(19) United States
(12) Patent Application Publication
(10) Pub. No.: US 2004/0231532 A1
(43) Pub. Date: Nov. 25, 2004

(54) Golf ball drawing tool

(76) Inventor: Chong-Yong Liu, Tainan City (TW)

Correspondence Address: Chong-Yong Liu, No. 2, Alley 492, Hai Tian Rd. Sec. 2, Tainan City, TW

(21) Appl. No.: 10/316,584

(22) Filed: Dec. 9, 2002

(51) Int. Cl. B41F 17/00

(52) U.S. Cl. 101/35

(57) ABSTRACT

A golf ball drawing tool, comprising by an annular base and a semicircle cap, is an easy equip to be revolved open and close depends on the usage, it is more accurate and easier to line the central line of the surface of the golf ball and to draw special symbols on the surface of the golf ball.

### BACKGROUND OF THE INVENTION

The present invention relates to a golf ball drawing tool comprises by an annular base and a semicircle cap.

A conventional golf ball drawing toll is used by a lineation machine or put on the one hand and the other hand holds a pen to drawing symbols.

### SUMMARY OF THE INVENTION

A golf ball drawing tool comprises by an annular base and a semicircle cap.

The semicircle cap having two produment rings extended from the bottom of the semicircle cap, riveting with the two symmetrical prominent pedestals on the two ends of the annular base by the rivets, revolving the semicircle cap to covering the golf ball on the annular base, lining out the outer central line of the surface of the golf, drawing the special symbols on the surface of the golf by the special symbol holes on the outer of the semicircle cap.

### BRIEF DESCRIPTION OF THE DRAWINGS

FIG. 1 is a perspective view of a golf ball drawing tool;

FIG. 2 is a perspective view of an annular base of the golf ball drawing tool without a golf ball;

FIG. 3 is a perspective view of an annular base of the golf ball drawing tool with a golf ball;

FIG. 4 is a perspective view of an annular base of the golf ball drawing tool with a golf ball and a semicircle cap covering half golf ball;

FIG. 5 is a diagram of drawing a symbol on the surface of a golf ball by using a golf ball drawing tool; and

FIG. 6 is a diagram of a symbol and a central line are draw on the surface of a golf ball.

### DETAILED DESCRIPTION OF THE INVENTION

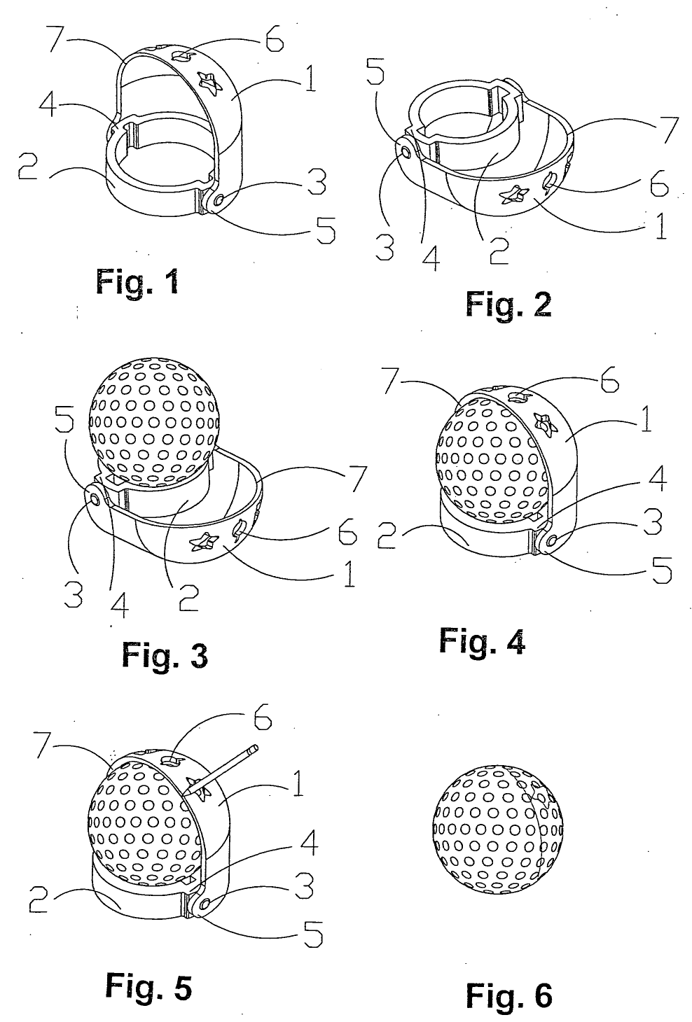

Referring to FIGS. 1 and 2, a golf ball drawing tool, comprises by an annular base 2 and a semicircle cap 1.

The annular base 2, having two symmetrical prominent pedestals 4 extending outwardly from the edges of the two sides tending, and the internal diameter of the annular base 2 is smaller than the diameter of a golf ball.

The semicircle cap 1, the shape depends on the size and form of the golf ball, having two convex rings 5 extending outwardly form the bottom of the semicircle cap 1, riveting the two convex rings 5 with the two prominent pedestals 4 on the two ends of the annular base 2 by the rivets 3, revolving the semicircle cap 1 to covering the golf ball on the annular base 2.

Referring to FIGS. 3-5, the semicircle cap covering the golf ball and the marginal arc line of the semicircle cap about be a pen nib apart from the superficial biggest circle on the golf ball, lining out the outer central line of the surface of the golf ball, and the semicircle cap 1 having several different special symbols holes 6 on the outer to help drawing the symbols on the surface of the golf ball.

Referring to FIG. 6, a symbol and a central line are draw on the surface of the golf ball.

To sum up, the golf ball drawing tool, have the advantages as following:

1. It is practical to help increasing the accuracy of push the golf ball.

2. It is newly that drawing a special symbol on the surface of the golf ball.

3. It is convenient for being carried and saving the place.

I claim:

1. A golf ball drawing tool, comprising:
an annular base, having two prominent pedestals extending outwardly from the edges of the two sides tending, the internal diameter of the annular base is smaller than the diameter of a golf ball; and
a semicircle cap, the shape depends on the size and form of the golf ball, having two convex rings extending outwardly form the bottom of the semicircle cap, riveting the two convex rings with the two symmetrical prominent pedestals on the two ends of the annular base by the rivets, revolving the semicircle cap to covering the golf ball on the annular base, lining out the outer central line of the surface of the golf for the target of pushing the golf ball.

2. The golf ball drawing tool in accordance with claim 1, wherein the semicircle cap having several different special symbols to help drawing the symbols on the surface of the golf ball.
